(19) United States
(12) Patent Application Publication
(10) Pub. No.: US 2016/0113838 A1
(43) Pub. Date: Apr. 28, 2016

(54) SYSTEMS AND METHODS FOR INHIBITING APNEIC AND HYPOXIC EVENTS

(71) Applicants: PRESIDENT AND FELLOWS OF HARVARD COLLEGE, Cambridge, MA (US); UNIVERSITY OF MASSACHUSETTS MEDICAL SCHOOL, Worchester, MA (US)

(72) Inventors: David PAYDARFAR, Newton, MA (US); James NIEMI, Concord, MA (US); Ian ZUZARTE, Worchester, MA (US); Premananda INDIC, Northborough, MA (US); Crystal KNODEL, Wayland, MA (US); John OSBORNE, Winchester, MA (US)

(73) Assignee: PRESIDENT AND FELLOWS OF HAVARD COLLEGE, Cambridge, MA (US)

(21) Appl. No.: 14/889,486

(22) PCT Filed: May 7, 2014
(86) PCT No.: PCT/US14/37115

§ 371 Date: Nov. 6, 2015

Related U.S. Application Data
(60) Provisional application No. 61/820,630, filed on May 7, 2013.

(51) Int. Cl. A61H 23/00

(52) U.S. Cl. CPC A61H 23/00; A61H 2230/405; A61H 2201/1602

(57) ABSTRACT

Systems and methods for inhibiting an occurrence of an apneic or hypoxic event are disclosed. Physiological data is received from a subject and analyzed to detect an impending apneic event or an impending hypoxic event. A stimulation is applied to the subject to inhibit occurrence of the impending apneic or hypoxic event after an occurrence of a predetermined condition. The physiological data can include respiratory data, cardiological data, or a combination thereof. The analyzing includes use of a point-process model and gross body movement data of the subject. Therapeutic effectiveness of the stimulation is increased by accounting for gross body movements of the patient.

Therefore, it would be useful to describe pathological instabilities of breathing, track the dynamics in real time, and lessen the severity of an apneic event or entirely prevent an apneic event.

### SUMMARY

According to one embodiment, a method for inhibiting an occurrence of an apneic or hypoxic event includes the acts of receiving physiological data from a subject, analyzing the received physiological data to detect at least one of an impending apneic event or an impending hypoxic event, and applying a stimulation to the subject to inhibit occurrence of the impending apneic or the impending hypoxic event. The physiological data includes respiratory data. The analyzing includes use of a point-process model and gross body movement data of the subject. The stimulating occurs after an occurrence of a predetermined condition.

According to another embodiment, a method for inhibiting an occurrence of an apneic or hypoxic event includes the acts of receiving physiological data from a subject, analyzing the received physiological data to detect at least one of an impending apneic event or an impending hypoxic event, and applying a stimulation to the subject to inhibit occurrence of the impending apneic or the impending hypoxic event. The physiological data includes circulatory data. The analyzing includes use of a point-process model and gross body movement data of the subject. The stimulating occurs after an occurrence of a predetermined condition.

According to yet another embodiment, a system for inhibiting an apneic event or a hypoxic event includes an analysis module and a stimulating mechanism. The analysis module is configured to receive physiological data from a subject and to analyze the received physiological data in real time. The physiological data includes cardiological data. The analysis includes using a point-process model to detect at least one of an impending apneic event or an impending hypoxic event and further includes use of a point-process model and gross body movement data of the subject. The stimulating mechanism is operatively coupled to the analysis module. The stimulating mechanism is configured to apply a stimulus to the subject. The applied stimulus inhibits the impending apneic event or the impending hypoxic event.

According to yet another embodiment, a system for inhibiting an apneic event or a hypoxic event includes an analysis module and a stimulating mechanism. The analysis module is configured to receive physiological data from a subject and to analyze the received physiological data in real time. The physiological data includes respiratory data. The analysis includes using a point-process model to detect at least one of an impending apneic event or an impending hypoxic event and further includes use of a point-process model and gross body movement data of the subject. The stimulating mechanism is operatively coupled to the analysis module. The stimulating mechanism is configured to apply a stimulus to the subject. The applied stimulus inhibits the impending apneic event or the impending hypoxic event.

Additional aspects of the invention will be apparent to those of ordinary skill in the art in view of the detailed description of various embodiments, which is made with reference to the drawings, a brief description of which is provided below.

### BRIEF DESCRIPTION OF THE FIGURES

FIG. 1A illustrates the interbreath interval of simulated data.

FIG. 1B is an instantaneous variance estimated by a point process model using the data of FIG. 1A.

FIG. 2 shows a Kolmogorov-Smirnov plot of time-rescaled quantiles derived from the simulated data of FIG. 1A.

FIG. 3A is an example from one continuous recording of a newborn rat.

FIG. 3B is a calculated variance of the data in FIG. 3A using the point process model.

FIG. 4A shows a Kolmogorov-Smirnov plot of time-rescaled quantiles derived for data of a newborn rat.

FIG. 4B shows an autocorrelation plot for the newborn rat data of FIG. 4A.

FIG. 4C shows a Kolmogorov-Smirnov plot of time-rescaled quantiles derived for data of a second newborn rat.

FIG. 4D shows an autocorrelation plot for the second newborn rat data of FIG. 4C.

FIG. 5A shows one continuous recording of a human infant interbreath interval.

FIG. 5B shows the calculated variance of the data in FIG. 5A using the point process algorithm.

FIG. 6A shows the Kolmogorov-Smirnov plot of the infant data of FIG. 5A.

FIG. 6B shows the Kolmogorov-Smirnov plot of a second infant data.

FIG. 6C shows the Kolmogorov-Smirnov plot of a third infant data.

FIG. 6D shows the Kolmogorov-Smirnov plot of a fourth infant data.

FIG. 7A shows an example of interbreath interval variance over time when stimulation was initiated.

FIG. 7B shows an example of interbreath interval variance over time when stimulation was terminated.

FIG. 8A shows a flowchart for an algorithm 700 to monitor physiological instabilities in real time.

FIG. 8B shows a system to monitor instabilities in breathing over time and control stimulation according to one embodiment.

FIG. 9 depicts the cross-section of a therapeutic mattress design that applies isolated stochastic resonance mechanostimulation to a portion of the mattress according to one embodiment.

FIG. 10 shows an exploded view of an active assembly according to one embodiment.

FIG. 11 shows results from the test of the single-bodied mattress compared to the isolation mattress of FIG. 9.

FIG. 12 shows a graph of mattress output for the isolation mattress, comparing the output of the active and passive regions.

FIG. 13 depicts measurement locations in one embodiment used for the mattress displacement tests.

FIG. 14 shows a system for focal stimulation according to one embodiment.

FIG. 15A shows a support structure or garment according to one embodiment.

FIG. 15B shows a support structure or garment according to another embodiment.

FIG. 16A depicts stimulation array according to one embodiment.

FIG. 16B depicts single piece of the stimulation array.

FIG. 17 shows graph of an example pulse plethysmograph signal and a pulse-plethysmograph-derived gross body movement amplitude signal.

FIG. 18 illustrates a receiver operating characteristic curve shown from the prediction scores of all sip patients used in an example study.

### DETAILED DESCRIPTION OF PREFERRED EMBODIMENTS

A point-process modeling framework may be used to develop algorithms for detecting and predicting life-threatening events in neonates. These life-threatening events include apnea, bradycardia, and hypoxia. A number of physiological signals may be monitored to automatically detect, and even predict the occurrence of life-threatening events. Detection or prediction of these events may decrease the severity of an event or even completely eliminate the event. Once detected, methods and systems may automatically apply a stimulus to a subject to decrease the severity of the event, revert the subject to the normal, rhythmic state, or even entirely prevent the occurrence of the event.

The application of stochastic resonance to non-linear physiologic systems may improve system performance. For example, the application of stochastic noise via mechanical vibration enhances the respiratory performance of infants with apnea and hypoxia. Additionally, it may be the case that stochastic resonance might also improve the pulmonary system's ability to optimize oxygen tension and gas exchange.

Modeling of Interbreath Intervals

Respiratory rhythm in mammals is governed by neural circuits within the brainstem that signal the timing and depth of each breath. Continuous ventilation results from recurrent bursts of inspiratory neuronal activity that controls the diaphragm via discrete phrenic motor neuron activations. One assumption that allows non-invasive measurement of neuronal inspiratory bursts is to assume that the peak of inspiration is a discrete event that marks the timing of neuronal inspiratory bursts. Another assumption that may be made is that interbreath interval dynamics are governed by continuous processes under the regulation of multiple feedback and feed-forward loops impinging upon the respiratory oscillator.

The interbreath interval of an infant follows a power-law distribution. The characterizing parameters of the power-law distribution are found to be sensitive to age (e.g., maturation). During a respiratory cycle, the end of inspiration and onset of expiration mark local maxima or local minima. For the purposes of this disclosure, the end of inspiration and onset of expiration will define local maxima unless otherwise noted. In an observation interval (0,T], the times where the local maxima occur may be defined as 0<u₁<u₂< . . . <uₖ< . . . <uₖ≦T. Then, for any given respiratory event uₖ, the waiting time until the next event obeys a history dependent log-normal probability density f(t|Hₖ,θ) as

$$f ( t \vert {H}_{k} , θ ) = {[ \frac{1}{2 π {{σ}^{2} ( t - {u}_{k} )}^{2}} ]}^{\frac{1}{2}} exp \{ - \frac{1}{2} \frac{{( ln ( t - {u}_{k} ) - μ ( {H}_{k} , θ ) )}^{2}}{{σ}^{2}} \} \qquad ( 1 )$$

Time t is any time greater than uₖ. Hₖ is the history of interbreath intervals up to uₖ represented as Hₖ={uₖ, wₖ, wₖ₋₁, . . . , wₖ₋ₚ₊₁} where wₖ is the k^{th} interbreath interval represented as wₖ=uₖ−uₖ₋₁. Theta (θ) is a vector of model parameters. The instantaneous mean is modeled as a p-order autoregressive process,

$$μ ( {H}_{k} , θ ) = {θ}_{o} + {\sum }_{j = 1}^{p} {θ}_{j} {w}_{k - j + 1} .$$

The probability density in equation (1) defines the interbreath interval distribution with μ and σ as the characterizing parameters. The local maximum-likelihood approach is employed to estimate θ and σ at each instant of time t.

The local joint probability density of uₜ₋₁: uₜ is used to calculate the local maximum likelihood estimate of θ and σ where l is the length of the local likelihood observation interval. If a number nₜ of peaks in this interval are observed as u₁<u₂< . . . <uₙ_{ₜ}≦t and if θ as well as σ are time varying, then at time t, the maximum likelihood estimate of \hat{θ}ₜ and \hat{σ}ₜ is to be the estimate of θ and σ in the interval l. Considering the right censoring, the local log likelihood is obtained as

$$log f ( {u}_{t - l : t} \vert {θ}_{t} ) = {\sum }_{i = 2}^{{n}_{t}} w ( t - {u}_{i} ) log f ( {u}_{i} - {u}_{i - 1} \vert {H}_{{u}_{i - 1}} , {θ}_{t} ) + w ( t - {u}_{{n}_{t}} ) log {\int }_{t - {u}_{{x}_{t}}}^{∞} f ( θ \vert {H}_{{u}_{{n}_{t}}} , {θ}_{t} ) d θ \qquad ( 2 )$$

where w(t) is a weighting function to account for faster updates to local likelihood estimation. The weighing function is w(t)=exp(−α(t−u)) where α is the weighting time constant that assigns the influence of a previous observation on the local likelihood at time t. The instantaneous estimate of the mean μ may be obtained using the autoregressive representation because θ can be estimated in continuous time. Similarly, the local likelihood estimate provides the instantaneous estimate of variance σ².

The interbreath interval probability model along with the local maximum likelihood method provides an approach for estimating the instantaneous mean and instantaneous variance of the interbreath interval. These measures provide information about the changes in the characteristics of the distribution and information related to the irregularity of breathing. The time-rescaled interbreath interval was computed to obtain a goodness-of-fit measure. The time-rescaled interbreath interval is defined as:

τₖ=∫ᵤ_{ₖ₋ₜ}^{u}^{ₖ}λ(t|Hₜ,\hat{θ}ₜ)dt (3)

where uₖ represents the breathing events observed in (0,T) and λ(t|Hₜ,\hat{θ}ₜ) is the conditional intensity function defined as:

$$λ ( t \vert {H}_{t} , {\hat{θ}}_{t} ) = {f ( t \vert {H}_{t} , {\hat{θ}}_{t} , {\hat{σ}}_{t} ) [ 1 - {\int }_{{u}_{{n}_{t}}}^{t} f ( θ \vert {H}_{θ} , {\hat{θ}}_{θ} , {\hat{σ}}_{θ} ) d θ ]}^{- 1} \qquad ( 4 )$$

The conditional intensity is the history dependent rate function for a point process that generalizes the rate function for a Poisson process. The τₖ values are independent, exponential, random variables with a unit rate. With a transformation zₖ=1−exp(−τₖ), the zₖ values become independent, uniform random variables on the interval (0,1]. A Kolmogorov-Smirnov test was used to assess the agreement between the transformed zₖ values and a uniform probability density. A Kolmogorov-Smirnov plot indicates agreement of the point-process model with the interbreath interval data series by plotting the transformed zₖ values versus the uniform density. A line close to the 45 degree diagonal from this plot indicates close agreement.

The Kolmogorov-Smirnov distance measures the largest distance between the cumulative distribution function of the transformed interbreath interval and the cumulative distribution function of a uniform distribution, both on the interval (0,1]. A shorter Kolmogorov-Smirnov distance indicates a better model in terms of goodness-of-fit.

Data were analyzed from both human and animals trials. Neonatal rats exhibit respiratory patterns and chemo-responses analogous to preterm infants. This includes both periodically occurring apnea episodes and sporadic apneas with bradycardia and hypoxemia. One- to two-day-old rats were placed in a sealed chamber and breathed through a face mask and pneumotachogram. Respiratory airflow was recorded through the mask. Pressure within the plethysmographically sealed chamber was measured and these measurements were used as an index of respiratory effort.

The tested preterm infant data included infants having a gestational age of less than 36 weeks and post-conceptional age greater than 30 weeks at the time of study. The infants were spontaneously breathing room air or receiving supplemental oxygen through nasal cannulae at a fixed flow rate. Respiratory inductance plethysmography of abdominal movements during spontaneous breathing (Somnostar PT; Viasys Healthcare, Yorbalinda, Calif.) was used to collect respiratory signal data at a sampling rate of 100 Hz.

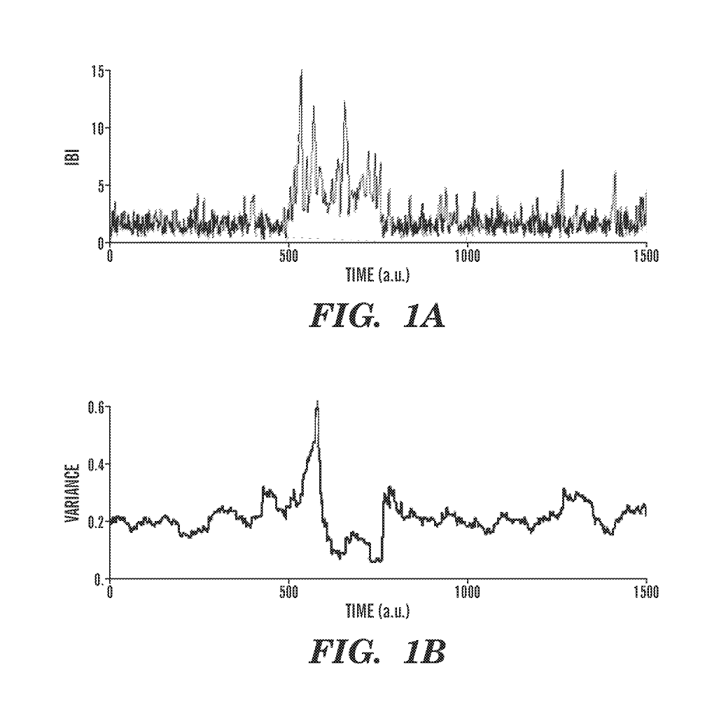

The model was first tested using simulated data sets. Interbreath interval data series were simulated from a log-normal distribution with set mean μ and variance σ² values. FIG. 1A illustrates one of the simulated data series. The interbreath interval (IBI) of the simulated data is plotted over time, which is shown with arbitrary units. The simulated data kept the interbreath intervals relatively stable between times of zero and 500 units. Then, the interbreath intervals experienced significant variance between times of 500 to 800 units. After the time of 800 units, the simulated interbreath intervals returned to same levels as between times of zero and 500 units. These data were generated by keeping the interbreath interval variance σ² at a fixed value for times zero to 500, then randomly altering the variance σ² for times 500 to 800, and then returning to the initial variance σ² for times greater than 800. The mean value μ was kept at a constant level. That is, times zero to 500 and times greater than 800 simulated non-apneic sleep and times 500 to 800 simulated the occurrence of apneic events.

Referring to FIG. 1B, the instantaneous variance estimated by the developed point process model of order p=4, with local likelihood window i=100 and weighting time constant α=0.01 along with a time resolution s=0.01 is shown for the data of FIG. 1A. As shown in FIG. 1B, the variance remained relatively constant at about 0.2 from times zero to 500, then sharply increased to about 0.6 and sharply fell to about 0.1 for times 500 to 800 before returning to about 0.2 for times after 800. This accurately estimated the mean μ and variance σ² for selected fixed mean μ and variance σ² values.

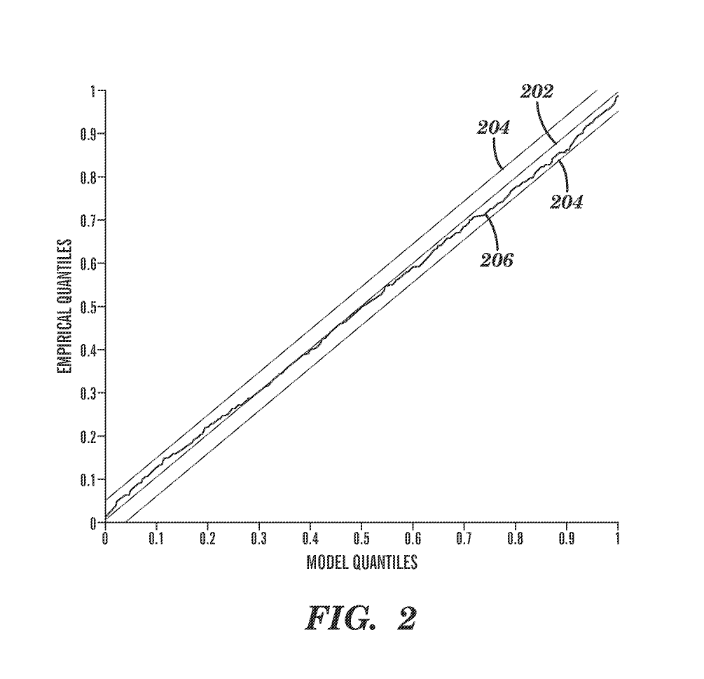

The goodness-of-fit of the point process model was analyzed. FIG. 2 shows a Kolmogorov-Smirnov plot of time-rescaled quantiles derived for the simulated data of FIG. 1A. The 95% confidence intervals 202 and theoretical values 204 were plotted along with the time-rescaled quantiles 206. A model is considered perfect if the quantiles 206 perfectly overlie the theoretical values 204. As shown, the time-rescaled quantiles 206 closely followed the line of theoretical values 204 and remain within the 95% confidence intervals 202.

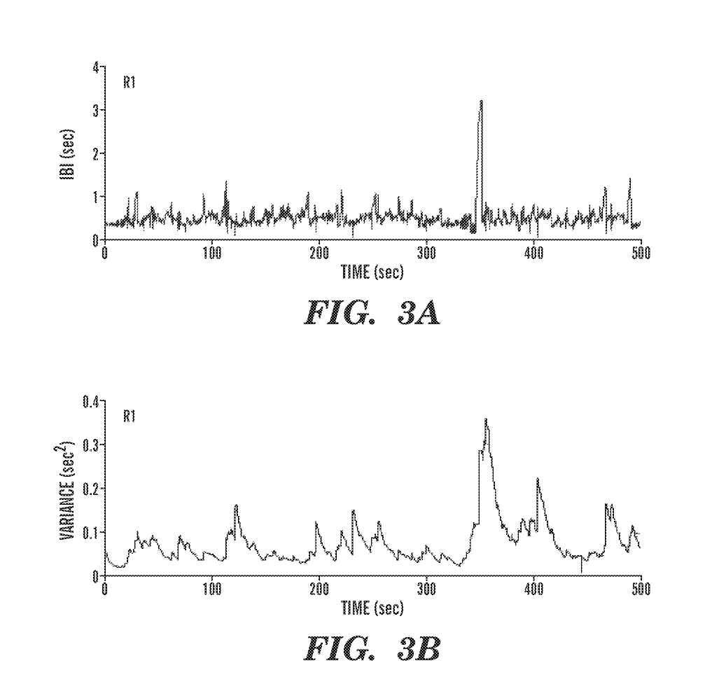

Referring to FIG. 3A, an example from one continuous recording of a newborn rat R1 is shown. FIG. 3A plots the interbreath interval (IBI) over time. As shown, the interbreath interval remained relatively stable and exceeded 1 second at relatively few points. In newborn rats, an interbreath interval greater than 1 second indicates apnea. Some peaks that exceed 1 second occurred at times of, for example, about 25 seconds, about 105 seconds, about 225 seconds, about 350 seconds, and about 490 seconds. As the apnea occurs, the variance increases.

The variance in the interbreath interval is an indicator of stability of breathing. FIG. 3B shows the calculated variance of the newborn rat R1 data in FIG. 3A using the point process algorithm. As shown, the variance remained relatively stable, with significant peaks formed at, for example, about 25 seconds, about 105 seconds, about 200, about 225 seconds, about 350 seconds, about 400 seconds, and about 490 seconds. These peaks correspond with the apneic interbreath interval peaks in FIG. 3A.

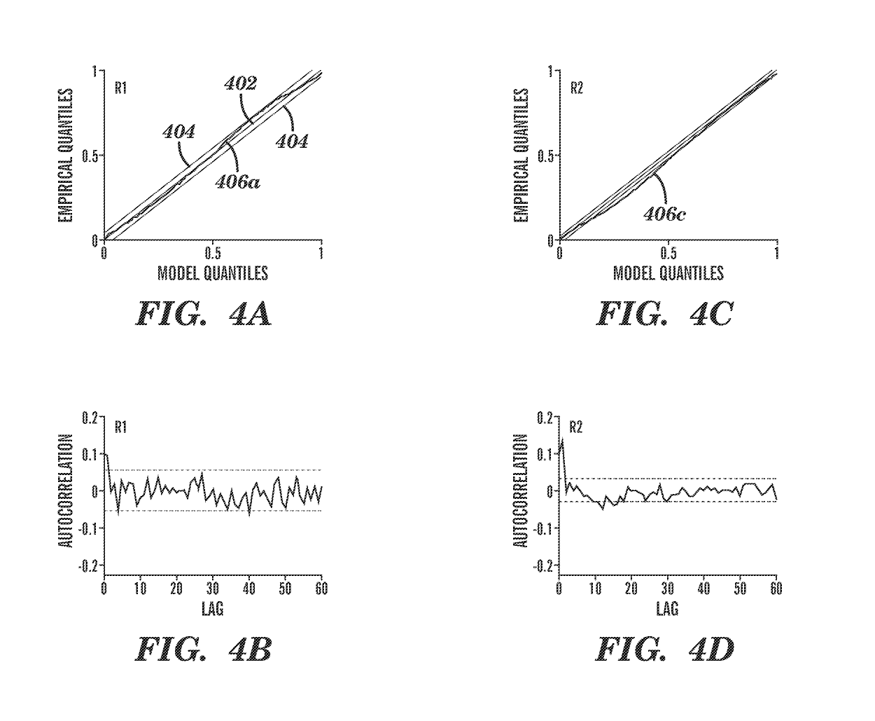

Referring to FIGS. 4A-4D, Kolmogorov-Smirnov plots of time-rescaled quantiles derived for data of two newborn rats R1, R2 was plotted along with the associated autocorrelation function for each. The theoretical values 402, 95% confidence intervals 404, and time-rescaled quantiles 406a,c for each newborn rat R1, R2 are shown in FIGS. 4A and 4C. The first newborn rat R1 was the same data used in FIGS. 3A and 3B. FIG. 4A shows the time-rescaled quantile 406a for the first newborn rat R1 closely following the theoretical values 402 along the 45 degree line, but approaching the upper 95% confidence interval 404 for model values between about 0.6 and about 0.8. FIG. 4B shows the autocorrelation of the first newborn rat R1 to remain within the corresponding confidence interval of (about ±0.05). FIG. 4C shows the time-rescaled quantile 406c for the second newborn rat R2 following the theoretical values 402 along the 45 degree line with a slight excursion beyond the lower 95% confidence interval 404 for model values between about 0.2 and about 0.4. FIG. 4D shows the autocorrelation of the second newborn rat R2 to remain within the corresponding confidence interval (about ±0.02).

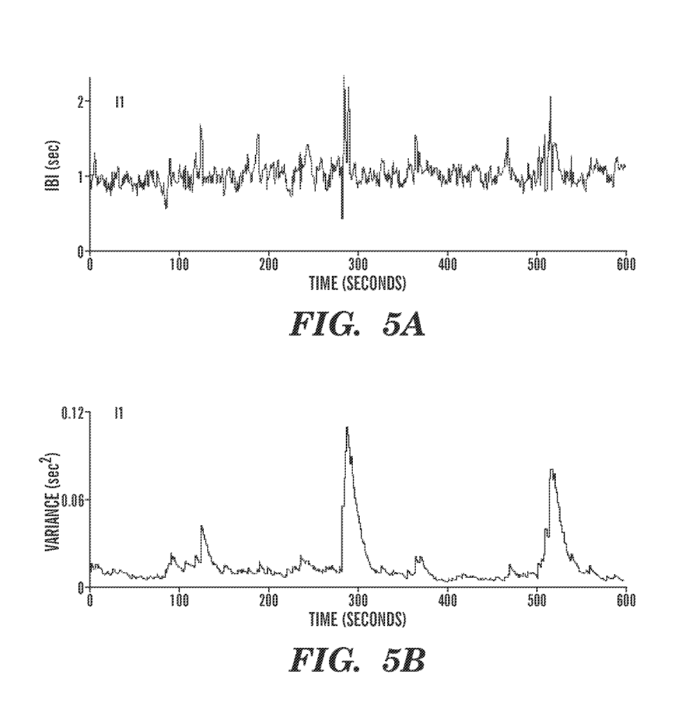

Referring to FIG. 5A, an example from one continuous recording of a human infant I1 is shown. The infant's I1 interbreath interval (IBI) remained at about one second peaks exceeding about 1.5 seconds at times of about 125 seconds, about 290, about 300 seconds, and about 510 seconds. In infants, the normal interbreath interval is about 1 second. Irregularity in breathing results in the interbreath interval varying from about 1 second to about 20 seconds. The change in interbreath interval is reflected as the variance.

FIG. 5B shows the variance of the interbreath interval data (FIG. 5A) of the infant I1. The instantaneous variance increased during the apnea, suggesting larger variability. The variance remained relatively steady at approximately 0.01 sec². Significant peaks were seen at times of about 125 seconds, about 290 to 300 seconds, and about 510 seconds.

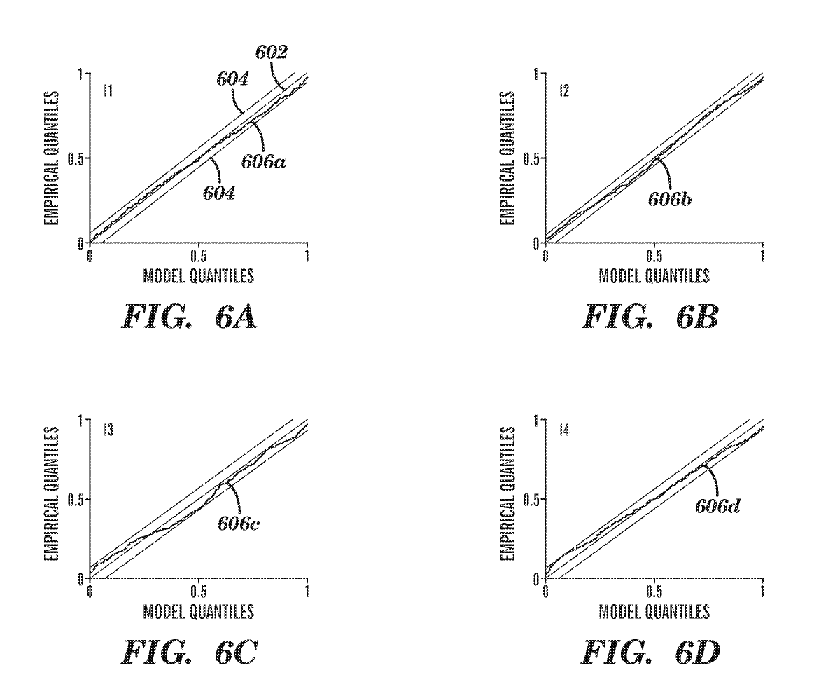

FIGS. 6A-6D provide the Kolmogorov-Smirnov plots from four infants I1-I4, respectively. FIG. 6A shows the Kolmogorov-Smirnov plot of the first infant I1 data from FIGS. 5A and 5B. The time-rescaled quantiles 606a for the first infant I1 closely track the theoretical values 602 along the 45 degree line, but approached the lower 95% confidence interval 604 for model quantiles of about 0.8 to about 1.0.

FIG. 6B shows the Kolmogorov-Smirnov plot of a second infant I2 data. The time-rescaled quantiles 606b for the second infant I2 closely tracked the theoretical values 602 along the 45 degree line, but approached the lower 95% confidence interval 604 for model quantiles of about 0.9 to about 1.0.

FIG. 6C shows the Kolmogorov-Smirnov plot of a third infant I3 data. The time-rescaled quantiles 606c for the third infant I3 tracked the theoretical values 602 along the 45 degree line. The time-rescaled quantiles 606c approached the upper 95% confidence interval 604 for model quantiles of about 0 to about 0.2 and approached the lower 95% confidence interval 604 for model quantiles of about 0.4 to about 0.6 and about 0.9 to about 1.0.

FIG. 6D shows the Kolmogorov-Smirnov plot of a fourth infant I4 data. The time-rescaled quantiles 606d for the fourth infant I4 closely tracked the theoretical values 602 along the 45 degree line. The time-rescaled quantiles 606d approached the upper 95% confidence interval 604 for model quantiles of about 0.1 to about 0.2 and approached lower 95% confidence interval 604 for model quantiles of about 0.9 to about 1.0.

The time varying evolution of the characterizing parameters were estimated to represent the dynamic nature of breathing and thereby provide a time-varying measure of irregularity in breathing according to Equation 1 above.

The instantaneous mean is modeled as a p-order autoregressive process as

$$μ ( {H}_{k} , θ ) = {θ}_{o} + {\sum }_{j = 1}^{p} {θ}_{j} {w}_{k - j + 1} \qquad ( 5 )$$

The probability density in Equation 1 defines the interbreath interval distribution with mean μ and variance σ as the characterizing parameters. At each instant of time t, a local maximum-likelihood approach was used to estimate μ and σ. To calculate the local maximum likelihood estimate of μ and σ, the local joint probability density of uₜ₋₁:uₜ l is defined as the length of the local likelihood observation interval. The maximum likelihood estimate of \hat{θ}ₜ and \hat{σ}ₜ is approximated as the estimate of θ and σ in the interval l at time t if nₜ peaks are observed within this interval as u₁<u₂< . . . <tₙ_{ₜ}≦t and if θ as well as σ are time varying. Thus, for a p-order of 4, Equation 1 becomes:

$$f ( t \vert {H}_{k} , θ ) = {[ \frac{1}{2 π {σ}^{2} {w}_{k}} ]}^{\frac{n - 2}{2}} exp \{ - \frac{1}{2} \frac{{( ln ( {w}_{k} ) - μ ( {H}_{k} , θ ) )}^{2}}{{σ}^{2}} \} \qquad ( 6 )$$

The order, p, can be set to a different level based on a particular application.

Given Eq (6), the local log-likelihood for an observation window nₜ can be defined as:

$$log f ( {u}_{t - l : t} \vert {θ}_{t} ) = {\sum }_{i = 2}^{{n}_{t}} w ( t - {u}_{i} ) log f ( {u}_{i} - {u}_{i - 1} \vert {H}_{{u}_{i - 1}} , {θ}_{t} ) + w ( t - {u}_{{n}_{t}} ) log {\int }_{t - {u}_{{n}_{t}}}^{∞} f ( ϑ \vert {H}_{{u}_{{n}_{t}}} , {θ}_{t} ) d ϑ \qquad ( 7 )$$

where w(t) is a weighting function to account for faster updates to local likelihood estimation. The weighing function was expressed as w(t)=exp(−α(t−u)) where α is the weighting time constant that assigns the influence of a previous observation on the local likelihood at time t. The instantaneous estimate of the mean μ is obtained using the autoregressive representation because θ can be estimated in continuous time. Similarly the local likelihood estimate provides the instantaneous estimate of variance σ² as

σ²=(ln(wₖ)−μₖ)²/nₜ (8)

Thus the instantaneous mean in Equation 5, along with the variance in Equation 8 determines the characterizing parameters of the algorithm that track the instability of breathing in real time.

Modeling of Heartbeat Intervals

Additionally or alternatively, other physiological signals can be monitored to detect or predict the occurrence of a life-threatening event. A point-process model was developed using electrocardiograph and respiratory signals as primary signals. All other physiological signals were used as covariates in the predictive algorithm.

The peak of the electrocardiogram, also known as the R-wave event, is treated as a point process. The distribution of the interbeat intervals is used for developing the probabilistic modeling framework for the algorithm. An interbeat interval is the time elapsed between two successive R-wave peaks and is also known as an R-R interval or RRI.

A probabilistic model of a dynamical system observed through a point process can be used to meaningfully analyze heartbeat data. The heartbeat intervals are the times between R-wave events. These R-wave events correspond to the electrical impulses from the heart's conduction system, which initiate ventricular contractions. Therefore, the R-wave events form a point process because the events are a sequence of discrete occurrences in continuous time. Additionally, the autonomic nervous system is the principal dynamic system that modulates the dynamics of the heartbeat intervals. Thus, premature infant heartbeats can be accurately characterized by point process models of the R-R intervals.

The point process framework can be related to other variables, including respiratory activity, movement, pulse and other related physiological variables. These relations may be used to establish new measures of control dynamics by the autonomic nervous system. A new statistical framework was developed using the indices obtained from the model. This combined framework combined measures sleep state, respiratory dynamics, and cardiovascular control for predicting life-threatening events in infants.

For any R-wave event uₖ, the waiting time until the next R-wave event obeys a history-dependent inverse-Gaussian probability density. This is expressed as f(t|Hᵤ_{ₖ},θ), where t is any time greater than uₖ, Hᵤ_{ₖ} is the history of R-R intervals up to uₖ, and θ is a vector of model parameters. The waiting time until the next R-wave event is also the length of the next R-R interval. The model is defined as:

$$f ( r \vert {H}_{{u}_{k}} , θ ) = \vert \frac{d t}{d r} \vert f ( t \vert {H}_{{u}_{k}} , θ ) = {[ \frac{{θ}_{p + 1}^{*}}{2 π r} ]}^{\frac{1}{2}} exp \{ - \frac{1}{2} \frac{{{θ}_{p + 1}^{*} [ 1 - {μ}^{*} ( {H}_{{u}_{k}} , θ ) r ]}^{2}}{{{μ}^{*} ( {H}_{{u}_{k}} , θ )}^{2} r} \} \qquad ( 9 )$$

where μ*(Hᵤ_{ₖ},θ)=c⁻¹μ(Hᵤ_{ₖ},θ) and θ*ₚ₊₁=c⁻¹θₚ₊₁. The mean and standard deviation of the heart rate probability density, respectively, are:

$$\begin{matrix}{μ}_{HR} = {{μ}^{*} ( {H}_{{u}_{k}} , θ )}^{- 1} + {θ}_{p + 1}^{* - 1} & ( 10 ) \\ {σ}_{HR} = {[ \frac{2 {μ}^{*} ( {H}_{{u}_{k}} , θ ) + {θ}_{p + 1}^{*}}{{μ}^{*} ( {H}_{{u}_{k}} , θ ) \cdot {θ}_{p + 1}^{* 2}} ]}^{\frac{1}{2}} & ( 11 )\end{matrix}$$

The mean in Equation 9 becomes

$$μ ( {H}_{{u}_{k}} , θ , ρ , γ , η ) = {θ}_{0} + {\sum }_{j = 1}^{p} {θ}_{j} {w}_{k - j + 1} + {\sum }_{j = 1}^{q} {ρ}_{j} {RESP}_{k - j + 1} + {\sum }_{j = 1}^{m} {γ}_{j} SaO {2}_{k - j + 1} + {\sum }_{j = 1}^{s} {η}_{j} {MOV}_{k - j + 1} … > 0 \qquad ( 12 )$$

where RESP refers to the instantaneous lung volume measure, SaO2 refers to arterial-blood oxygen saturation, and MOV refers to movements monitored by electromyographic signals. The values of each are sampled in correspondence to the beat series because they are considered together with autoregressions on the R-R intervals. All other physiological signals act as covariates. Additionally, the amplitude of the respiration is included as one of the covariates because both the amplitude and the timing are important features to define the stability of breathing. It is contemplated that one or more of these covariates (e.g. the amplitude of the respiration) may be excluded from analysis.

Both the maximum local likelihood algorithm and the adaptive filtering algorithm were used to fit the model with covariates to the data. This allows for estimation of new indices of cardiovascular control defined as a function of the parameters θ=[θ₀ . . . θₚ], ρ=[ρ₁ . . . ρ_{q}], γ=[γ₁ . . . γ_{q}], η=[η₁ . . . ηₛ].

The model for interbreath interval is the same as discussed above with the mean interbreath interval defined by considering other physiological signals as covariates. The dynamics of poles of the auto-regression as well as the instantaneous power can serve as indices of the cardio-respiratory dynamics because the instantaneous mean is represented as an autoregressive process in both the interbreath interval model and the R-R interval model. The respiratory system was considered stable if the poles were inside the unit circle and unstable if the poles were outside of the unit circle. The degree of instability is defined using the number of poles outside the unit circle.

The resulting indices of cardio-respiratory dynamics are related to the life-threatening events including sleep state as a variable in the probability function. The model seeks to characterize the probability of onset of a life threatening event given the infant's physiological and autonomic state, as:

Pr(Apnea)=f(Sleep,Hₜ_{ₖ},θ,ρ,γ,η) (13)

This function was modeled using a framework including classifiers, regression analysis, principal component analysis, state vector machines, and adaptive filters, namely a Kalman filter. The function includes the indices defined for the R-R interval as well as interbreath interval. For the R-R interval model and interbreath interval models, a parametric approach was pursued. This approach characterized specific indices from the auto-regression models. The parameters were estimated using local likelihood and/or adaptive algorithms. The model fits were tested using well-established goodness-of-fit analysis. After determining the functions, indices extracted from this new explicit framework were used to statistically assess the predictive power of the model across the available database, both with and without vibrotactile stimulation.

The observations outlined above can be used to develop systems and devices that measure, indicate, and initiate other processes when a predetermined condition is met (e.g, a specified interbreath interval, R-R interval, and/or interbreath interval variability condition). The initiation of other processes can take many forms. One non-limiting example is to warn an individual when a predetermined condition is met or predetermined boundaries are crossed. The warning could include, for example, triggering an alarm, illuminating a light, initiating a sound, altering a display device such as a monitor, creating notes in medical records or chart recordings, sending a text alert such as an e-mail, SMS, or MMS message, and/or sending an automated phone call. Additionally or alternatively, a corrective therapy can be automatically applied upon the happening of a predetermined condition. One non-limiting example would be to initiate therapeutic vibration of a neonatal mattress for avoiding apnea or hypoxia. Moreover, a single device can perform multiple functions such as the example of a neonatal mattress with sensor, actuators, and computation incorporated measuring respiration of an infant and using algorithm and process described to initiate a therapy or action to stimulate and restore breathing.

The point process model was applied to an existing infant database in order to understand the respiratory dynamics related to mechanosensory stimulation. It was shown that the variance of the interbreath intervals is an important indicator of instability of breathing, with higher variance indicating irregular breathing and increased risk of apnea or hypoxia and lower variance indicating the stable breathing patterns and decreased risk of apnea or hypoxia.

It was expected that stimulation would induce rapid changes in interbreath interval variance because mechanoreceptor stimulation affects the respiratory oscillator via neural signals. Surprisingly, analysis of eleven infants revealed that the respiratory system exhibits relatively slow dynamics in interbreath interval variance in response to both initiation and removal of mechanoreceptor stimulation.

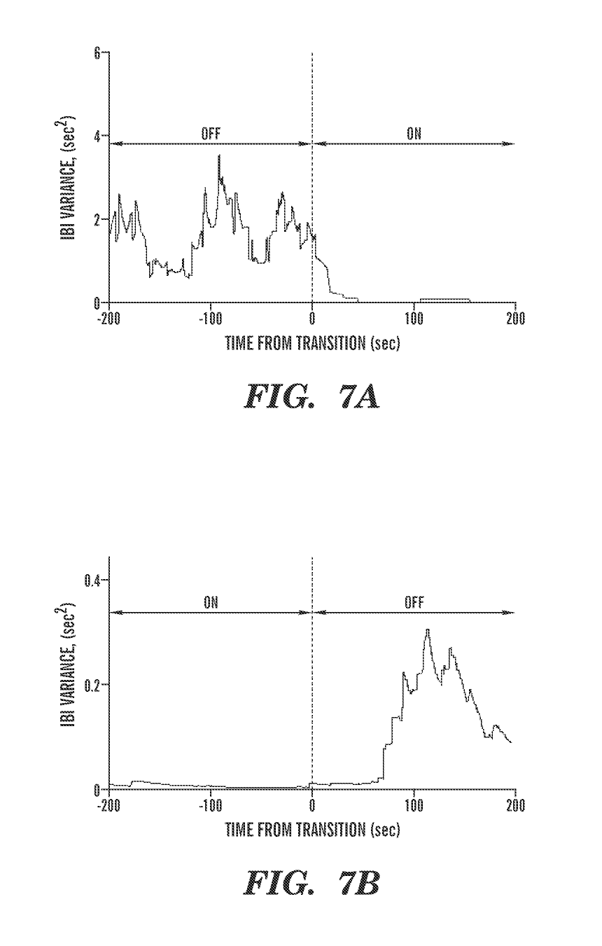

Referring now to FIGS. 7A and 7B, an example of the change in interbreath interval variance in response mattress stimulation is shown. FIG. 7A shows interbreath interval variance over time when the mattress stimulation was initiated. During times −200 to 0, no stimulation was present and the interbreath interval showed considerable variance. Stimulation was initiated at time 0. Once stimulation was initiated, the variance began to decline until no variance was noticed at approximately 60 seconds. Between 60 and 200 seconds there is almost no variance present.

FIG. 7B shows interbreath interval variance over time when the mattress stimulation was removed. During times −200 to 0, stimulation was present and the interbreath interval showed almost no variance. Stimulation was terminated at time 0. Once stimulation was terminated, the level of variance remained at almost zero until a sharp increase at approximately 60 seconds. Between 60 and 200 seconds, variance began fluctuating again. The study of eleven infants showed that the interbreath interval variance evolved to the new level within approximately one minute.

The interbreath interval data in FIGS. 7A and 7B was obtained by implementing the point process model of respiration. This revealed a parameter that is necessary for a device to prevent apnea. As shown in FIGS. 7A and 7B, impending apnea must be anticipated within approximately one minute in order to actuate the mechanosensory stimulus in time to prevent the apnea. Similarly, removal of the stimulus could result in persistent beneficial after-effects that maintain stability of breathing for up to approximately one minute after cessation of the stimulus. It is contemplated that this lag time might be different depending on factors such as post-conceptional ages, gestational age, concurrent conditions that might affect signaling within the respiratory control system, monitoring method, etc. The respiratory response time to stimulation onset and offset can be estimated for data sets from individual infants, and the resultant time constant can be automated and incorporated into the algorithm used to control the actuators that provide feedback mechanosensory stimulation to the respiratory control system.

In accordance with one embodiment, the present invention can be used to track the instability of breathing in infants, and in particular, preterm infants. Preterm infants with post-conceptional age of less than 36 weeks commonly have irregular breathing patterns with periodic and sporadic pauses in breathing. Variance has been shown to be a good marker for the incidence of apnea and hypoxia events.

It is essential to correctly quantify the irregularity of the breathing patterns, so that appropriate magnitude as well as duration of mechanosensory (vibrotactile) stimulation can be provided to improve the breathing patterns in preterm infants.

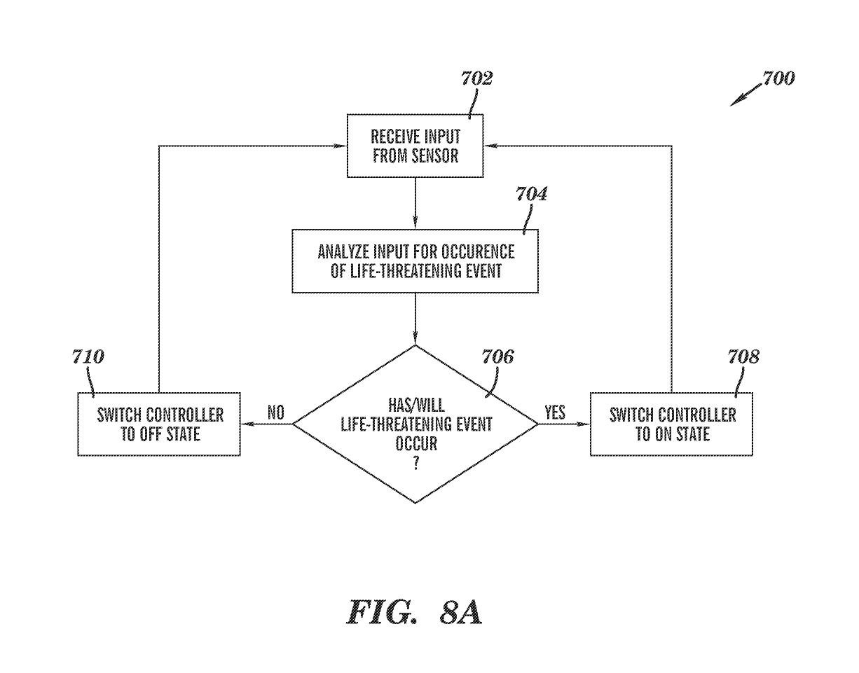

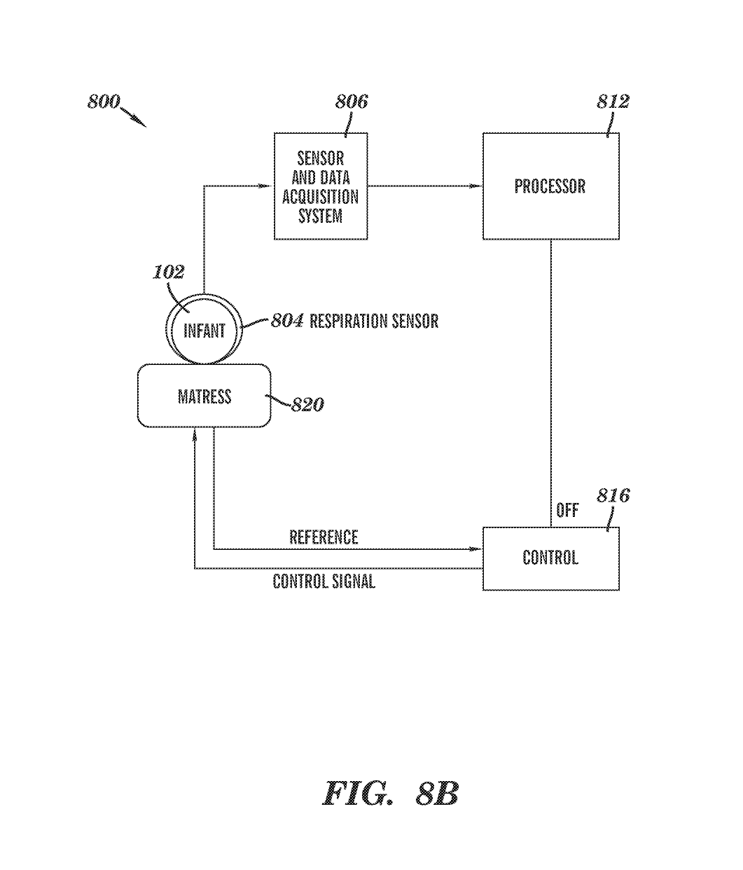

In accordance with one embodiment of the invention, FIG. 8A shows a flowchart for an algorithm 700 to monitor physiological instabilities in real time. Characterizing parameters (e.g. variance, heartbeat) can be used to assess likelihood of a life-threatening event occurring based on the monitored physiological factors. Step 702 receives input from sensors. By way of non-limiting example, these sensors can monitor heartbeat and/or breathing patterns. Step 704 analyzes the input for the occurrence of a life-threatening event. The occurrence of the life-threatening event may either be occurring contemporaneously with the analysis and monitoring, or it may occur in the future. By way of non-limiting example, a threshold value can be set while monitoring instantaneous breathing variance. At decision box 706, it is determined whether a life-threatening event has or will occur. By way of non-limiting example, a threshold or set-point for variance indicates whether or not a life-threatening event has occurred. If the value is above a certain threshold, a life-threatening event has occurred.

If the algorithm detects that a life threatening event has or will occur, a controller is switched to the ON state at step 708. The controller is adapted to deliver vibrotactile stimulation to the source of monitored input (e.g. an infant). The algorithm 700 continues to receive input from the input sensor at step 702. It is contemplated that the controller may remain in the ON state for a predetermined amount of time, or until a precondition is met.

If the algorithm does not detect a life threatening event at decision box 706, the controller is biased to the OFF state at step 710. The algorithm 700 then continues to receive input from the sensor at step 702.

FIG. 8B shows a system 800 that monitors instabilities in breathing in real time according to one embodiment. The system 800 of FIG. 8B includes a respiration sensor 804, a sensor and data acquisition system 806, and a controller 810. The system 800 includes a vibrotactile stimulation mattress 820, which is connected to the controller 810. The respiration sensor 804 can be fastened to an infant 802 by, for example, a band or strap. The respiration sensor 804 measures the respiration of the infant 802. The sensor and data acquisition system 806 receives signals from the respiration sensor 804 and produces a respiration signal that is input to a respiration signal processor 812 of the controller 810. The respiration signal processor 812 uses the respiration signal to produce a variance value. The variance value can be compared to a threshold or set-point by a compare module (e.g., software module, hardware component, comparator, etc.) and used to turn ON or OFF a mattress controller 816. The mattress controller 816 is generally biased in the OFF status, until the variance meets or exceeds the threshold. When the mattress controller 816 is in the ON state, the mattress 820 produces one or more stimuli to restore breathing.

Movement Features

A number of physiological perturbations result from spontaneous gross body movement, including increased oxygen consumption due to metabolic demands, movement induced hyperventilation and hypocapnea, and disruption of quiet sleep. These perturbations lead to a destabilizing effect on respiratory control and hence the occurrence of movement serves as an important physiological marker in predicting impending apneic and hypoxic events. What is more, gross body movements may be predictive of apneic events and hypoxic events for causal reasons such as movements that trigger hyperventilation, which in turn leads to hypocapnia. Gross body movements could also be predictive of apneic events and hypoxic events for symptomatic reasons such as movements that occur in response to a change in the underlying physiological state that is itself the causal factor leading to apnea.

Additionally, the quality of physiological data being monitored, particularly data obtained from respiratory and pulse plethysmogram signals, is adversely affected by gross body movements. These gross body movements are typically present in about one-quarter of recording times. Thus, features derived from gross body movement patterns can also incorporated into an analysis to improve prediction of apneic or hypoxic events.

Movement estimation is also useful in building statistical models of the joint feature distributions because it helps to explain the existence of movement artifacts in other measurement modalities. For example, one complication in interpreting previous prediction results on the same data set is the presence of movement artifacts in the IBI estimates. Surprisingly, the conflation of gross body movement with breathing signals indicates that the predictive value of respiratory measurements may be primarily due to information about breathing dynamics, primarily due to information about movement patterns, or even due to information about both.

One way to improve prediction of apneic and hypoxic events is to incorporate gross body movement data into the analysis of physiological factors. Gross body movement data can be collected using independent sensors to detect movement, extracted from sensors measuring other physiological data such as IBI and/or RRI, or a combination thereof. In one nonlimiting example, sensors are used to directly collect gross body movement data. Preferably, sensors collect the gross body movement data without being in constant contact with the body of the patient.

In some aspects, the contactless sensor measures electrical signals in a conductive material placed proximate the patient. The electrical signals can include disturbances in an electrical field of the sensor that is caused by movement of the body of the patient. The conductive material could be included within a mattress, an array of individual sensors, a mat, a conductive plate, a probe, textiles worn by or covering the patient, etc. In one nonlimiting example, capacitive coupling between the patient's body and the conductive probe or surface is used to detect movement. In another nonlimiting example, a conductive plate or series of plates could be used to indicate motion due to a change in electrical capacitance between two specific plates.

In some aspects, the contactless sensor measures a change in force. That change in force can be detected using, for example, strain gauges or pressure sensors. The strain gauges and/or pressure sensors can be included within a mattress, an array of individual sensors, a mat, etc.

In some aspects, the contactless sensor includes an optical sensor. The optical sensor can be configured to detect electromagnetic radiation in the visible spectrum, infrared spectrum, ultraviolet spectrum, etc. In one nonlimiting example, the optical sensors detect changes in patterned light or a laser curtain.

In some aspects, the contactless sensor includes accelerometers, temperature sensing devices, gas sensing devices, and/or microwave-based Doppler sensors. Gas sensors can be used to detect the concentration of, for example, carbon dioxide. The level of carbon dioxide detected can then be correlated to increased or decreased levels of oxygen consumption.

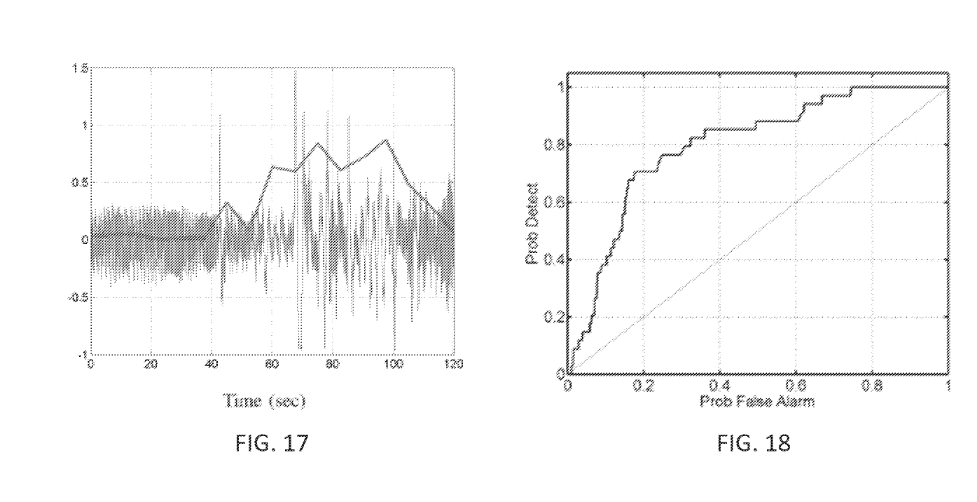

Additionally or alternatively, gross body movement data can be derived from sensors configured to collect other physiological data. In one nonlimiting example, movement data is extracted from a pulse plethysmogram (PPG) signal. The PPG signal can be collected using, for example, a pulse oximeter attached to the patient. The output of the PPG includes both a pulse waveform and a power in low-frequency bands during movement of the patient. This output can be used to obtain a PPG-derived movement signal. The PPG-derived movement signal is obtained by calculating power of the low frequency band relative to total power of the PPG signal. The ratio is calculated to normalize the highly variable nature of PPG signals. FIG. 17 shows graph of an example pulse plethysmograph signal and a pulse-plethysmograph-derived gross body movement amplitude signal. As shown, the unit variance of the PPG signal varies rapidly between about 0.3 and −0.3 units from 0 seconds until about 40 seconds. Then, after about 40 seconds, the PPG signal begins to change its variance pattern and also increases the amplitude of variance, e.g., from about 1.5 to about −0.9 at about 70 seconds. The line placed over the PPG signal data is the PPG-derived movement amplitude signal. This signal is normalized and ranges between 0 and 1. As shown, the movement signal is approximately 0 until about 35 seconds, then rises to about 0.4 units at about 45 seconds. The movement signal continues to generally rise to about 0.8 units at about 75 seconds and about 95 seconds. The movement signal then begins to descend to about 0 units at about 120 seconds.

Statistical features can be used to describe the distribution of movement values. In some aspects, three statistical features are used. These features include the local mean μₘ and the standard deviation σₘ of the movement signal, as well as the ratio of these quantities. In some aspects, a denominator term is used to attenuate the ratio when the mean is small. The denominator term is shown in Equation 14.

$$\frac{{σ}_{m}}{0.001 + {μ}_{m}} \qquad ( 14 )$$

Six patients were tested using systems and methods of the present disclosure. The subjects were monitored for both respiratory and cardiovascular signals. The respiratory and cardiovascular signals were always used when both were available. A total of 2030 minutes of data was recorded across all six patients. Of that, only 15 minutes were discarded due to unavailability of either respiratory or cardiovascular sensor data. Additionally, physically implausible IBI and RRI values were automatically removed. The remaining values were then resampled at 10 Hz using shape-preserving piecewise cubic interpolation. The signals were then log-transformed and converted to standard units (zero mean, unit variance) for each patient. The log transformation made the IBI and RRI signals approximately normally distributed, and thus, well described by second order statistics.

A discrete plethysmograph signal was analyzed using a wavelet-based algorithm to derive information about gross body movement. The continuous wavelet transform of the discrete plethysmograph signal was determined as the convolution of the scaled and translated version of a mother wavelet. A Morlet wavelet was used to transform the data in time frequency plane. A Morlet wavelet is a plane wave modulated by Gaussian function. A dyadic representation of scales with eight sub-octaves per octave was used to obtain fine resolution in the time-frequency plane. The transformed data was used to calculate a wavelet power spectrum in a normalized scale. All peaks in the normalized spectrum were derived using a peak detection algorithm at each instant of time. These peaks were used to derive a dominant power time series. It was determined that the peak value in the range of about 0.8 seconds to about 5 seconds correlates with the strength and duration of the gross body movement seen in the data by using different time scales.

Machine Learning

Beneficially, accurate prediction of impending apneic and/or impending hypoxic events can be increased using machine learning analysis. Accurate prediction of impending events results in an increased efficacy of stimulation. In some aspects, prediction performance is increased using a data set of a population. The data set includes physiological data from the population and is analyzed using a machine learning analysis. In some aspects, prediction performance is increased using a historical data set of the patient. The data set includes physiological data from the subject that was taken at earlier points in time. These earlier points in time can include the patient's present sleep cycle and/or previous sleep cycles.

Surprisingly, one method to increase prediction performance is to adapt techniques from the field of automatic speaker recognition. The approach in automatic speaker recognition is to form a statistical background model from all speakers in a database, then to form a model tuned to a particular speaker using Bayesian adaptation from the background model. The statistical models are Gaussian Mixture Models (GMMs) that are weighted combinations of multiple Gaussian densities.

In some aspects, a separate background GMM is trained that is individualized to each patient. This GMM encodes the feature densities arising from all of the encountered physiological states of the patient. Bayesian adaptation can be used to form both a preapnea GMM and an interapnea GMM from this background model by using training data from the patient's preapnea and interapnea periods.

Evaluation of each adapted GMM model was performed using 40-fold cross-validation where the nearest training data to each test segment was separated by at least two minutes. The small data sets were made more robust using the combined likelihoods of an event from ten independently trained GMMs. Specifically, ten different background GMMs were obtained using independent random initializations. This resulted in the adaptation of ten preapnea and interapnea GMMs. The single-frame prediction score was then a 2-class log-likelihood ration obtained from the log of the sum of the ten preapnea GMM likelihoods minus the log of the sum of the ten interapnea GMM likelihoods. Multi-frame prediction scores were obtained by adding the preapnea and interapnea log-likelihood rations over time. This was done using the maximum cumulative sum statistic over a time interval of two minutes and fifty seconds.

The probability of prediction was analyzed by finding the fraction of eligible apneas that are predicted within the prediction time window when given a prediction threshold. The probability of false alarm is the number of interapnea frames that the prediction window is triggered divided by the total number of interapnea frames. Thus, increasing or decreasing the duration of the prediction window will increase or decrease both probabilities, respectively. The prediction time window was kept fixed at 5.5 minutes and a receiver operating characterizing (ROC) curve was obtained for each patient by varying the prediction threshold. The area under the ROC curve (AUC) was used as the evaluation metric. FIG. 18 illustrates a ROC curve generated from the prediction scores of all six patients used in the example study. The AUC in FIG. 18 is 0.80. This AUC was compared against AUC values obtained from random surrogates. The single-frame vectors were held constant while the apnea clusters were shuffled in time. One constraint placed on the shuffling was that all successive apneas that were separated by less than 9.5 minutes were assigned to the same apnea cluster. Another constraint was that the within-cluster inter-apnea time distances were kept constant. The between-cluster instances were randomly varied, but were kept greater than 9.5 minutes apart. 500 surrogate apnea profiles were generated for each patient. Machine learning, temporal integration, and prediction evaluation were done independently for each of the surrogate profiles. One-sided p values were computed by comparing the algorithm's AUC scores from the real data to the distribution of AUC scores obtained using the random surrogates.

Table 3 summarizes the apnea prediction results obtained from the six patients.

TABLE 3
APNEA PREDICTION PERFORMANCE

| | RRI, Movement | RRI-IBI, Movement | Combined |
|---|---|---|---|
| Patient No. | AUC (p) | AUC (p) | AUC (p) |
| 1 | .90 (.02) | .89 (.00) | 72.0 |
| 2 | .78 (.02) | .50 (.48) | 72.4 |
| 3 | .80 (.02) | .80 (.01) | 74.7 |
| 4 | .62 (.27) | .67 (.17) | 76.0 |
| 5 | .88 (.01) | .85 (.01) | 74.5 |
| 6 | .69 (.39) | .91 (.08) | 74.7 |
| 1-6 | .77 (.00) | .75 (.00) | 72.9 |

The left column of Table 3 summarizes the results when testing RRI features plus movement features. The middle column summarizes the results when testing joint RRI-IBI features plus movement features. The right column shows the results when the GMM likelihoods from these two feature combinations are summed prior to computing the single-frame log-likelihood ration. Combining both classifiers in this way produced the best results overall. Significance (p<0.05) was obtained on five out of six patients. The highest net AUC value was 0.80. These improvements are attributable to two factors. The first is the addition of a PPG-derived movement signal. The second is the replacement of a Gaussian classifier with a GMM classifier. These two factors may contribute approximately equally to the overall improvement.

Isolation Mattress

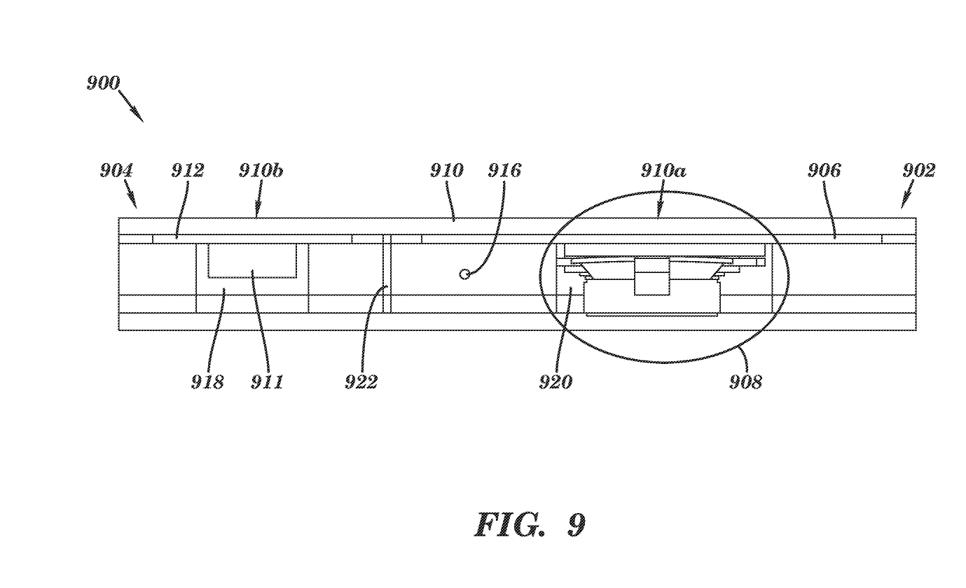

FIG. 9 depicts an isolation mattress 900 that applies isolated stochastic resonance mechanostimulation to a specific portion of the mattress according to one embodiment. The isolation mattress 900 includes a body 916. The body 916 includes an active region 902, a passive region 904, a top surface 910a, 910b, and a plurality of voids 918, 920, 922. The active region 902 includes an actuator 908 attached to an active soundboard 906. The passive region 904 includes an inertial device 914 attached to a passive soundboard 912. A passive-section void 918 is located around the inertial device 914. An active-section void 920 is located around the actuator 908. A soundboard void 922 is located between the active and passive soundboards 906, 912.

The active region 902 interacts with parts of an infant's body that can receive stimulation with little or no adverse consequences. These body parts include the legs and torso of the infant. The active region 902 is generally rectangular and occupies top surface 910a area, which is about two-thirds of the isolation mattress 900. It is contemplated that other shapes and sizes may be used be used to obtain the above described benefits.

The active soundboard 906 and the actuator 908 impart vibrational stimulation on the top surface 910a in the active region 902. The actuator 908 is attached to the active soundboard 906 such that movement of the actuator 908 moves the active soundboard 906. The active soundboard 906 is disposed below the top surface 910a such that at least a portion of the vibrations are imparted on the top surface 910a. For example, the active soundboard 906 can be placed approximately one-half inch below the top surface 910a. It is contemplated that other distances may be employed to achieve desired physical and vibrational properties of the top surface 910. For example, the soundboard may be placed from 0.4 inches to 0.6 inches, from 0.25 inches to 0.75 inches, from 0.1 inches to 1.0 inch, or even greater than 1.0 inch from the top surface 910. Inches

The passive region 904 interacts with parts of an infant's body that are more sensitive to stimulation, such as the head. The passive region 904 is shown as being generally rectangular and occupies top surface 910a area, which is about one-third of the total top surface area of the isolation mattress 900. It is contemplated that other shapes and sizes may be used be used to obtain the above described benefits. It is additionally contemplated that the size of the active region 902 relative to the passive region 904 may be altered.

The passive region 904 is mechanically isolated from the active region 902. The inertial device 914 is attached to the passive soundboard 912 such that the inertial device 914 helps to dampen vibrations from the active soundboard 906 and actuator 908. In the illustrated embodiment, the inertial device 914 is a passive inertial device a mass attached to the passive soundboard 912. This mass is 660 g of aluminum rigidly attached to the passive soundboard 912. It is contemplated that the masses may be made of different materials or weights. It is also contemplated that the inertial device 914 may be a device that actively cancels vibrations imparted on the passive soundboard 912.

The body 916 may comprise various materials. By way of non-limiting example, an open-cell foam, gel, or other viscoelastic material may be used to damp the vibrations from the active soundboard 906 and the actuator 908. Additionally, the voids 918, 920, 922 assist in inhibiting vibrations from passing to the passive section. The passive-section void 918 prevents or inhibits vibrations from being imparted to the inertial device 914. The active-section void 920 prevents or inhibits the actuator 908 from imparting vibrations on the body 916. The soundboard void 922 prevents or inhibits vibrations from directly passing between the active soundboard 906 and the passive soundboard 912. It is also contemplated that any or all of the plurality of voids may be replaced with visco-elastic damping materials that alter and/or modify the transmission of vibrations from the active soundboard 906 and actuator 908 to the passive region 904. By way of non-limiting example, Young's Modulus, density, and/or visco-elastic properties may be considered when selecting materials. Sufficiently dissimilar material may result in improved isolation characteristics because vibration transmission between materials is a function of the area of contact in addition to the impedance of the materials to a specific type of vibration.

Additionally, the isolation mattress 900 may indicate the active and the passive regions 902, 904 to an individual. Examples of this include using visual indicia on the top surface 910, the body 916, and/or on a cover placed over the isolation mattress 900. The cover may be made from, for example, polymeric materials including medical grade vinyl.

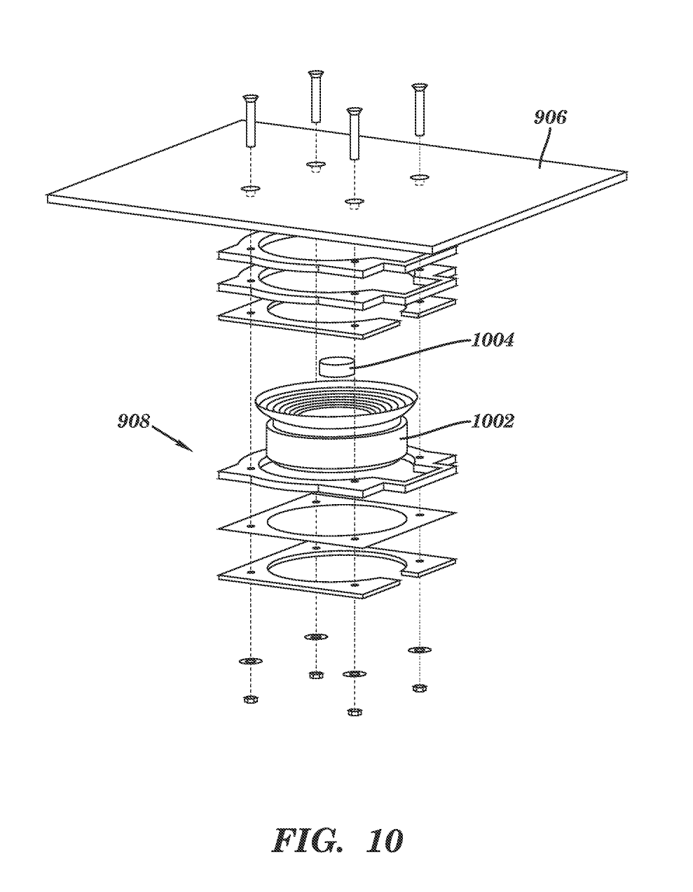

Referring now to FIG. 10, an exploded view of the actuator 908 is shown with the active soundboard 906 according to one embodiment. In the illustrated embodiment, the movement of the actuator 908 is obtained by imparting a drive signal to an audio driver 1002. A mass 1004 was added to the audio driver 1002 to increase output.

The isolation mattress 900 was tested against a single-bodied mattress. Both mattresses were 23 inches long, 12 inches wide, and 3.25 inches tall. All soundboards were located one-half inch below the top surface of the mattress.

The specifications for the single-bodied mattress included: an active soundboard being plywood; an actuator being a “woofer” audio driver of unknown origin; a body being a low-density foam rubber material; and the surface covering being a vinyl material.

The specifications for the isolation mattress 900 used in testing included: the active and passive soundboards 906, 912 being acrylic plastic; the inertial device 914 being a 660 g aluminum mass; the actuator 908 being an MCM model 1170 “woofer” audio driver that was modified to remove the driver cone and shorten the overall height; a 38.6 g mass 304 stainless steel mass was added to the audio driver; and the body was low-density polyurethane foam rubber material (UL94HF-1).

The first signal source consisted of a waveform generator connected to Class A/B current amplifier. This source was used to drive 2V peak-to-peak sinusoidal voltages in order to determine the transfer function of the isolation mattress 900 in the frequency band of interest. The frequencies used were: 10 Hz, 20 Hz, 30 Hz, 40 Hz, 50 Hz, 60 Hz, 70 Hz, 80 Hz, 90 Hz, 100 Hz and 200 Hz. These individual frequencies were used to de-convolve the system transfer function, but the results are not described herein. The second input source was a signal generator configured in the 30 Hz to 60 Hz range at various output settings (e.g. turns). Due to limited availability of the Balance Engineering generator for part of the testing, the third signal source consisted of ten 100 second recordings of the loaded output of the Balance Engineering generator from 1 turn to 10 turns (in 1 turn increments), sampled at 10 kSps, played back via National Instruments LabVIEW SignalExpress software and a National Instruments PCI-6281 Data Acquisition card connected a custom Class A/B current amplifier.

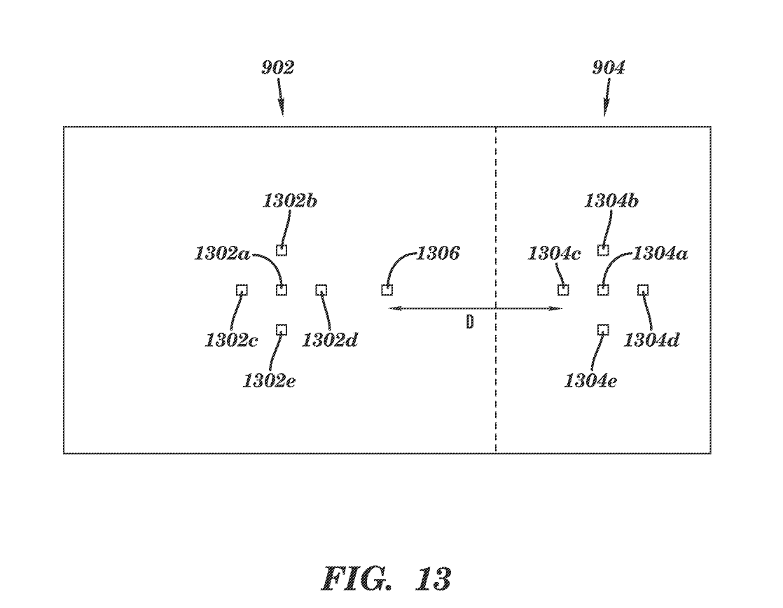

The isolation mattress was marked with reflective tape for accurate displacement measurements with the MTI-2100. As seen in FIG. 13, tape was placed at centers 1302a, 1304a of the active and passive regions 902, 904, respectively. Tape was also placed at points three inches above, to each side of, and below the centers 1302a, 1302b (1302b-e and 1304b-e, respectively) for a total of ten measurement locations. Measurements were also taken to determine the delivered stimulus and percentage isolation for the head if the infant were placed on the physical center point 1306 of the isolation mattress 900 rather than being placed on the center 1302a of the active region 902. Point 1304c was used to describe displacement at the infant's head because it was 5″ away from the mattress center 1306. As with the previous characterization, surface displacement measurements were collected using the MTI-2100 Fotonic Displacement system on an air table.

All measurements with the MTI-2100 system were taken using a Model 2062R fiber optic probe in its Range 1 measurement configuration. The linear range for the Model 2062R probe the Range 1 configuration was 152 μm with a nominal sensitivity of 0.025 μm. Each recording period was 100 seconds for every test, regardless of stimulus type. The output of the MTI-2100 system was recorded at 10 kSps and stored into a text file using a Tektronix MSO4034B digital oscilloscope. The stimulus drive voltage and drive current were also recorded at this frequency.

The recorded results were processed using MATLAB® in a similar manner to the methods of the previous characterization. Symmetric 3-pole high-pass Butterworth filters (cut-off of 1 Hz) and low-pass Butterworth filters (cut-off of 4 kHz) were applied to the data. The power spectral density was calculated using Welch's method with a spectral frame size of 1 Hz and a resolution sensitivity of 1.1 Hz. The Root-Mean-Squared value for output displacement was computed using a single window because it yielded more accurate results with less computational time than a sliding window of 0.1 seconds.

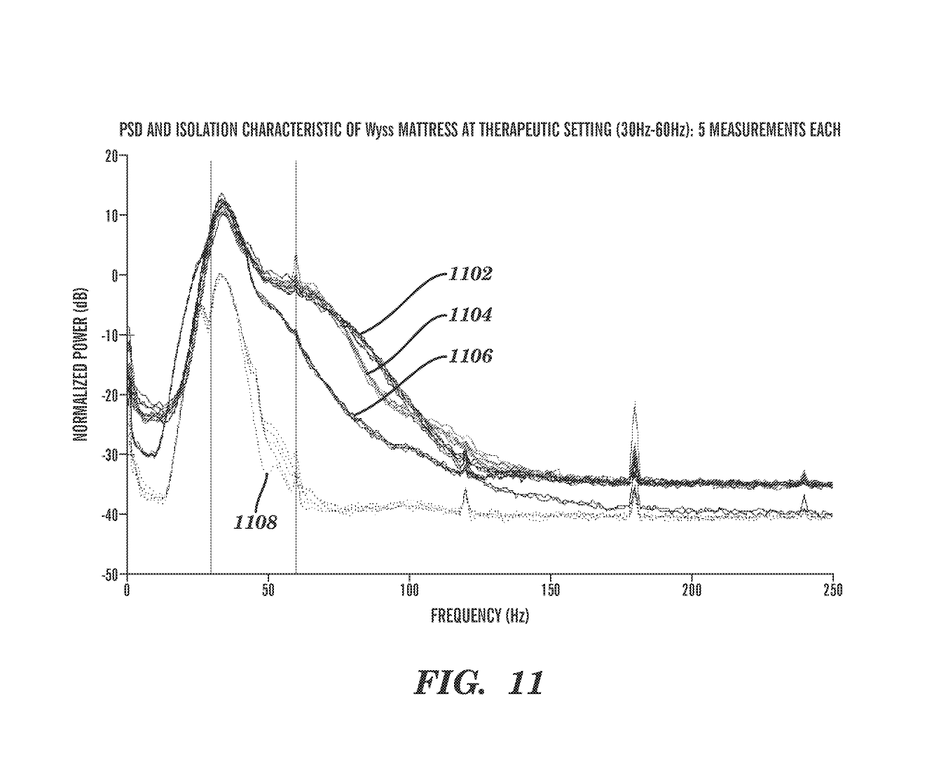

FIG. 11 shows results from the test of the single-bodied mattress compared to the isolation mattress with active and passive regions. The isolation mattress was the same as described in FIG. 9. Line 1102 represents readings from the tested single-bodied mattress at the center of stimulation for 1.5 turns. Line 1104 represents readings from the single-bodied mattress measured at the location of an infant's head for 1.5 turns. Line 1106 represents readings from the isolation mattress measured at the active region center 1302a at 2.75 turns of the signal generator, which was determined to produce the same therapeutic amplitude as the single-bodied mattress at 1.5 turns. Line 1108 represents readings from the isolation mattress measured at the passive region center 1304a at 2.75 turns. The output power spectral density of the isolation mattress closely matched the single-bodied mattress from 4 Hz-43 Hz, but the delivered power drops off from 44 Hz-60 Hz. The difference above 44 Hz may have been caused by the outer vinyl skin of the tested isolation mattress internally adhering to the body of the mattress. A similar attenuation was seen in previous single-bodied mattress characterization when a 1.5 kg mass was placed on the mattress.

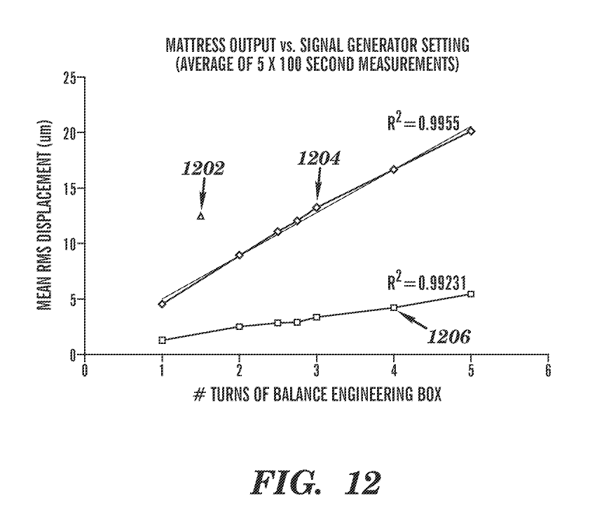

Referring now to FIG. 12, a graph of mattress output is shown. Point 1202 is the output of the single-bodied mattress. Line 1204 is the output of isolation mattress at the active region center 1302a. Line 1206 is the output of the isolation mattress at the passive region center 1304a. Table 1 lists the measured values shown in the graph with a calculation of the percent attenuation between the active region center 1302a and the passive region center 1304a.

TABLE 1
RMS Displacement Values and Percent Attenuation for the
Isolation Mattress

| Stimulus | Mean Active | Mean Passive | |
|---|---|---|---|
| Generator | Region Center | Region Center | Active Center to |
| setting | RMS Displacement | RMS Displacement | Passive Center |
| [turns] | [μm] | [μm] | Attenuation [%] |
| 1 | 4.5 | 1.3 | 72.0 |
| 2 | 8.9 | 2.5 | 72.4 |
| 2.5 | 11.0 | 2.8 | 74.7 |
| 2.75 | 12.1 | 2.9 | 76.0 |
| 3 | 13.2 | 3.4 | 74.5 |
| 4 | 16.7 | 4.2 | 74.7 |
| 5 | 20.1 | 5.5 | 72.9 |

As shown in table 1, there was a drastic reduction in displacement between the active center and the passive center. The attenuation between the centers was consistently between 72% and 76% across the tested range. That is, the isolation mattress 900 prevented approximately three quarters of the stimulation of the active region from reaching the passive region.

The secondary positions 1304c, 1306 provide data related to the attenuation of vibration between the approximate the head and body positions of an infant placed on the isolation mattress. Table 2 compares attenuation between an infant's head and body using the above described single-bodied mattress and the isolation mattress 900.

TABLE 2
Comparison of Single-bodied and Isolation Mattresses

| | Stimulus | Mean Mattress | | |
|---|---|---|---|---|
| | Generator | Center RMS | Mean Head RMS | |
| | Setting | Displacement | Displacement | Attenuation |
| | [turns] | [μm] | [μm] | [%] |
| Single- | 1.5 | 12.5 | 11.0 | 12.2 |
| bodied | | | | |
| Isolation | 2.75 | 8.4 | 2.6 | 69.5 |

Comparing the attenuation of the overall mattress center to the approximate head location for both mattresses resulted in the isolation mattress showing an improvement of 5.7 times over the single-bodied mattress.

The therapeutic level of stimulation of the single-bodied mattress was determined to be 1.5 turns of the amplifier on the noise generator as determined by comparison to previous tests. Therapeutic level of stimulation may be any stimulation that is capable of altering a sleep state or physiological function of sufficient amplitude to cause harm or or pain. This includes subthreshold, subarousal, and/or suprathreshold stimulation. The isolation mattress was tested to determine the turns needed to achieve an equivalent level of output stimulation. It was determined that 2.75 turns was the appropriate therapeutic setting for the isolation mattress. At this setting, the mean root-mean-squared displacement of the center 1302a of the active region 902 is comparable to the therapeutic displacement of the geometric center of the single-bodied mattress.

Sensors for direct monitoring and/or control of mattress surface displacement may be incorporated with the isolation mattress 900. These sensors can include, for example, embedded accelerometers or other vibratory sensors (e.g. pressure sensors, load cells, optical sensors). Such sensors can be used, for example, in modifying the drive signal for the active region in response to weight, loading, or the location of the infant on the mattress. Such sensors can be used, for example, in alerting caregivers to malfunctions or even active cancellation of stimulation in the passive region.

Focal Stimulation

In another embodiment, focal stimulation may be used to apply stochastic resonance stimulation to a subject. Systemic vibration may be potentially inappropriate for patients who are at risk of intra-ventricular hemorrhage. Instead, focal stimulation can be used to both discover and target the correct mechanoreceptors to therapeutically address different modes of respiratory instability. Additionally, focal stimulation can deliver only the essential stimulation when required. Focal stimulators may be used to apply mechanical stochastic resonance stimulation to improve the respiratory function of infants at risk of apnea or other respiratory instabilities. The stimulation may be applied in both open- and closed-loop fashions.

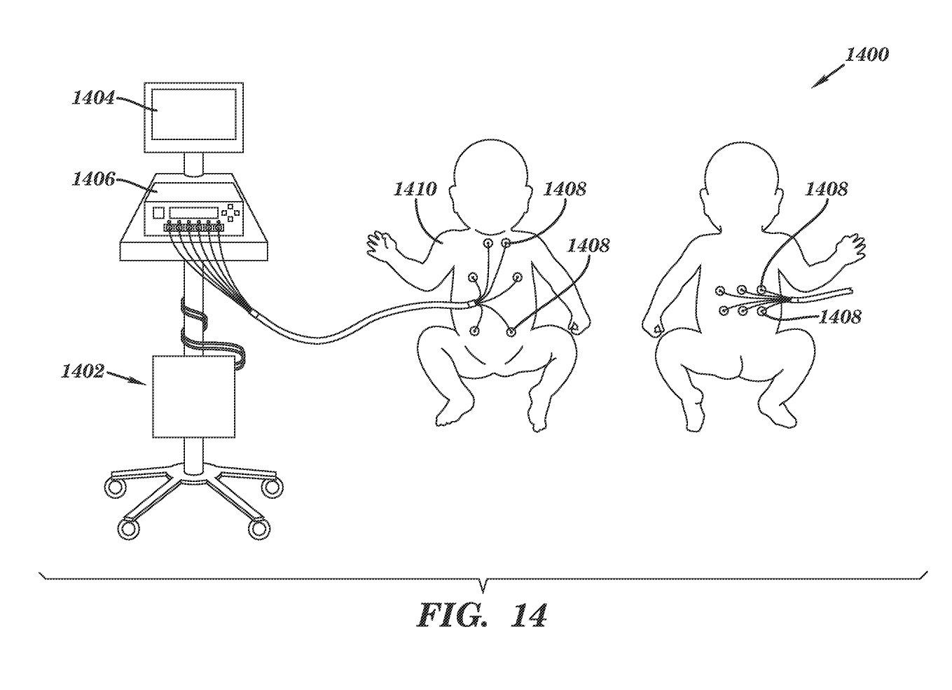

Referring now to FIG. 14, a focal system 1400 is shown according to one embodiment. The system 1400 includes a processor 1402, a user interface 1404, a signal generator 1406 and a plurality of focal stimulators 1408. The focal stimulators 1408 are applied to a body of a subject 1410 to stimulate to the subject. The system may additionally include a communications bus, data logging mechanism, and/or connections for input sensors. The communications bus provides an interface to attach external master controllers such as a laptop to the system 1400. The data logging mechanism may be used to locally store and/or report data. Input sensors such as temperature sensors, accelerometers, strain gages, pulse-oximeters, plethysmographs and other physiologic monitoring sensor systems may interface with the system to provide physiological information related to subject. This physiological information may be monitored and used by the system to initiate or alter stimulation.

The focal stimulators 1408 may be comprised of one type or a combination of types of actuators including electromagnetic, electromechanical, solid state actuators (e.g., Nitinol, piezoelectric), hydraulic, pneumatic, ferrofluid, electroactive polymer, etc. In the illustrated embodiment, the plurality of focal stimulators 1408 is designed to be placed in direct contact with the subject's skin. Thus, in this embodiment, it is desirable for the focal stimulators 1408 to be formed from biocompatible and/or hypoallergenic materials. For safety, the focal stimulators may also include double-electrical insulation so that the subject is protected from electrical discharge or electromagnetic interference.

The signal generator 1406 drives the focal stimulators 1408 and may drive them individually, in groups, or even as one unit. The signal generator 1406 may be, for example, a stochastic resonance noise generator and may include adjustable drive capabilities to ensure the delivery of adequate stimulation. The needed signal may be affected by conditions such as the stimulators being placed in an intervening brace or other mediating material. The focal stimulators 1408 may be applied to the subject using a number of materials such as braces, fitted garments, elastic bands, FDA-approved adhesives, etc.

The system 1400 may be used to control and optimize focal stimulation in response to an infant's real-time physiological status. For example, the system may monitor the infant's respiratory pattern and initiate stimulation to prevent or inhibit the occurrence of an impending apneic event or an impending hypoxic event. Additionally, the system 1400 may be used in developing algorithms to control and optimize focal stimulation. The use of physiological input sensors allows the device both to self-calibrate and deliver the correct stimulation independently of the attachment method and to dynamically adapt that stimulation during use.

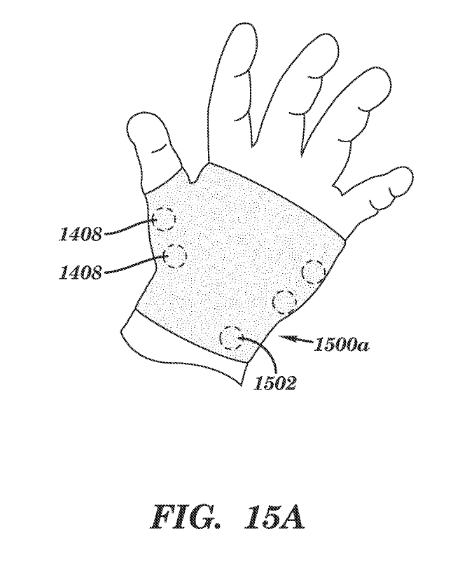

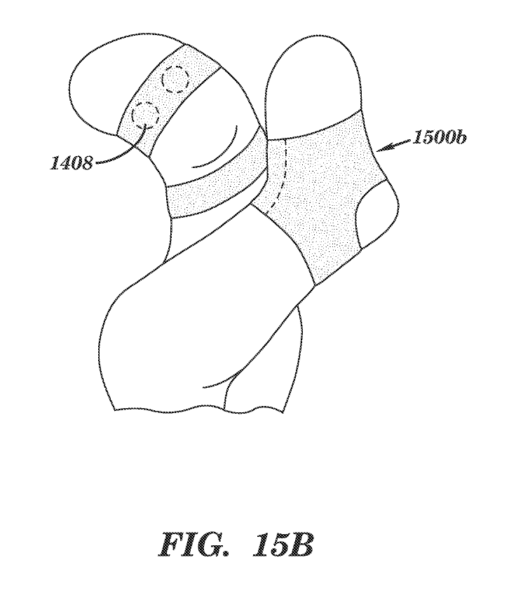

Referring now to FIGS. 15A and 15B, non-limiting examples of support garment structures for embedded focal stimulators are shown. Support garment structures may be made of a variety of materials including flexible materials such as neoprene, latex, rubber, silicone, cloth, wool, vinyl, polyvinyl chloride, nitrile, neoprene, knit textiles, composites, or leather. FIG. 15A shows a hand support structure 1500a that fits on the hand of an infant. The hand support structure 1500a includes a plurality of focal stimulators 1408 configured to apply stimulation to an isolated body part of the infant. In the illustrated embodiment, the body part is the infant's hand. Additionally, the hand support structure 1500a includes an input sensor such as, temperature sensors, blood pressure sensors 1502, accelerometers, strain gauges, pulse-oximeters, plethysmographs, and other physiological monitoring sensor systems that will assist in enabling the embedded focal stimulators 1408 during an apneic event or hypoxic event. FIG. 15B shows a foot support structure 1500b that fits on the foot of an infant and includes embedded focal stimulators 1408.

It is contemplated that the system may be condensed to a single embedded controller. The embedded controller includes algorithms developed to optimize the stimulation level and stimulation timing, and includes the integration of multiple types of sensors. The embedded controller may autonomously control the application of stochastic resonance stimulation based on either input sensors or a physician's programmed therapeutic regimen. These input sensors monitor at least one physiological condition. The placement and method of attachment of the focal stimulators 1408 also factor into the algorithm for the application of stimulation. Such a system may be condensed, simplified, and battery powered so that it may be designed for safe and efficacious use in home environments. Additionally, portions of the system such as sensors may communicate wirelessly with other portions of the system to decrease wires and increase safety.

Array Stimulation

In yet another embodiment, array stimulation may be used to apply stochastic resonance stimulation to a subject. Array stimulation can be used to deliver targeted stimulation while covering an area for potential stimulation. Additionally, array stimulation can deliver synchronized stimulation patterns over the array. Array stimulators may be used, for example, to apply stochastic resonance stimulation to improve the respiratory function of infants at risk of apnea or other respiratory instabilities. The stimulation may be applied in various ways such as single-actuator stimulation, multiple-actuator stimulation, or even coordinated stimulation such as stroking.

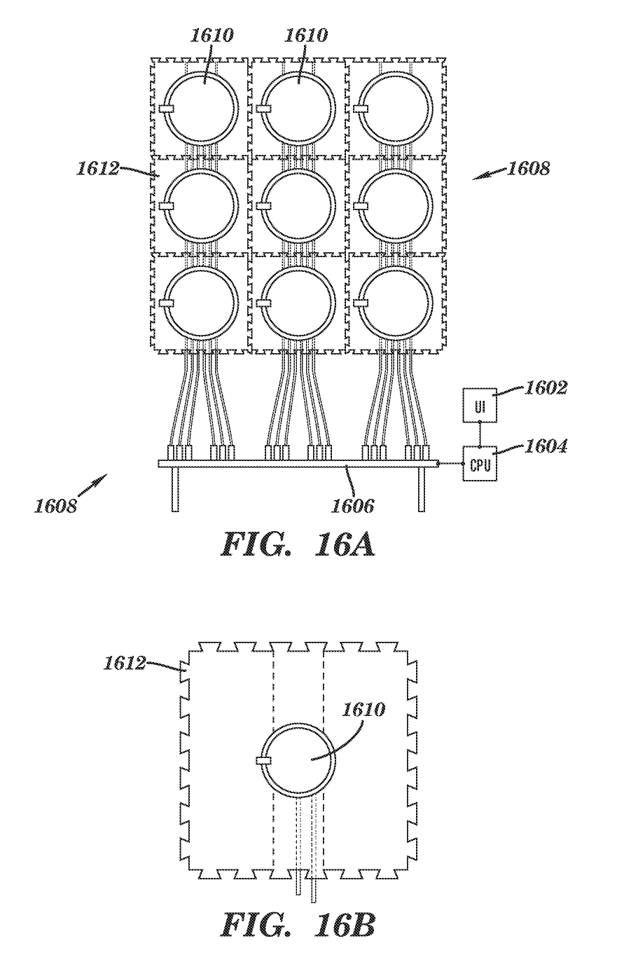

FIG. 16A depicts a stimulation array system 1600 according to one embodiment.

The stimulation array system 1600 includes a user interface 1602, a processor 1604, a controller 1606, and a stimulation array 1608. The stimulation array includes stimulators 1610 to stimulate a subject. Other components may include a communications bus, data logging mechanism, and/or connections for input sensors.

The user interface 1602 allows the user to interact with the stimulation array system 1600 and is operatively connected to the processor 1604. The processor 1604 is operatively connected to the controller 1606. The controller 1606 is operatively connected to the stimulation array 1608 and drives the stimulators 1610. In this embodiment the stimulators 1610 are driven independently. It is contemplated that the stimulators 1610 may also be driven in groups.

In this embodiment stimulation array 1608 includes interlocking pieces 1612. Each interlocking piece 1612 includes a single stimulator 1610. By way of non-limiting example the stimulators may be electromagnetic, electromechanical, solid state actuators (e.g., Nitinol, piezoelectric), hydraulic, pneumatic, ferrofluid, electroactive polymer, etc. It is contemplated that more than one stimulator 1610 may be included on an interlocking piece 1612. It is additionally contemplated that the stimulation array 1608 may be a single mat.

The array system 1600 may be used to control and optimize focal stimulation in response to an infant's real-time physiological status. For example, the system may monitor the infant's respiratory pattern and initiate stimulation to prevent or inhibit the occurrence of an impending apneic event or an impending hypoxic event. The use of physiological input sensors allows the device both to self-calibrate and deliver the correct stimulation independently of the attachment method and to dynamically adapt that stimulation during use.

Additionally, the array system 1600 may include sensors to detect the location of a child on the stimulation array 1608. Detecting the location of the child allows the array system 1600 to target stimulation. This targeted stimulation can be used to deliver stimulation only to portions of the stimulation array 1608 occupied by the child, simulate a stroking motion, or simulate a wave motion. Additionally, detecting the location may also be used to determine orientation of a child. Determining orientation would allow for targeted stimulation of the child's body without stimulating the child's head regardless of the child's location. The sensors to determine location may be included with the stimulation array 1608 or may be independent of the stimulation array 1608.

In accordance with the above embodiments, the vibrotactile stimulation can be turned on and turned off for a predefined periods of time. Alternatively the vibrotactile stimulation can remain on until a change in one or more aspects of the breathing pattern are detected. Further, the nature of the stimulation can change over time such that the amplitude, frequency characteristics, and/or period of vibration can change over time.

While the invention is susceptible to various modifications and alternative forms, specific embodiments and methods thereof have been shown by way of example in the drawings and are described in detail herein. It should be understood, however, that it is not intended to limit the invention to the particular forms or methods disclosed, but, to the contrary, the intention is to cover all modifications, equivalents, and alternatives falling within the spirit and scope of the invention as defined by the appended claims.

1. A method for inhibiting an occurrence of an apneic or hypoxic event comprising the acts of:
receiving physiological data from a subject including respiratory data;
analyzing the received physiological data to detect at least one of an impending apneic event or an impending hypoxic event, the analyzing including use of a point-process model and gross body movement data of the subject; and
applying a stimulation to the subject to inhibit occurrence of the impending apneic or the impending hypoxic event after an occurrence of a predetermined condition.

2.-47. (canceled)
